(19) United States
(12) Patent Application Publication
(10) Pub. No.: US 2017/0032040 A1
(43) Pub. Date: Feb. 2, 2017

(54) INFORMATION COLLECTION MANAGEMENT DEVICE, INFORMATION COLLECTION METHOD, AND INFORMATION COLLECTION SYSTEM

(71) Applicant: KABUSHIKI KAISHA TOSHIBA, Tokyo (JP)

(72) Inventor: Yu KANEKO, Kawasaki (JP)

(21) Appl. No.: 15/220,570

(22) Filed: Jul. 27, 2016

(30) Foreign Application Priority Data
Jul. 28, 2015 (JP) 2015-148986

(51) Int. Cl. G06F 17/30

(52) U.S. Cl. CPC G06F 17/30864; G06F 17/30519

(57) ABSTRACT

According to one embodiment, an information collection management device includes a computer including at least one processor. The computer is configured to obtain local schedules from a plurality of crawlers, the local schedules each defining a timing of an acquisition process for corresponding one of the crawlers to acquire data; and adjust the local schedules such that overlapping in the acquisition processes is reduced.

### CROSS-REFERENCE TO RELATED APPLICATIONS

This application is based upon and claims the benefit of priority from Japanese Patent Application No. 2015-148986, filed Jul. 28, 2015; the entire contents of which are incorporated herein by reference.

### FIELD

Embodiments of the present invention relate to an information collection management device, an information collection method, and an information collection system.

### BACKGROUND

Software (crawler) that acquires sensor data from sensor devices installed in a building or a factory via a network is used. In general, the crawler needs to meet requirements such as not putting excessive loads upon the sensor devices, maintaining acquisition intervals of the sensor data, and smoothness of the traffic occurring due to acquisition of the sensor data. The maintenance of the acquisition intervals of the sensor data is important for visualization and analysis of the sensor data. In addition, the smoothness of the traffic is important for prevention of packet loss.

Traditionally, a crawler that generates a schedule for acquisition of the sensor data has been advocated for meeting the above requirements. This crawler can meet the above requirements by acquiring the sensor data in accordance with the generated schedule.

However, the above traditional crawler does not contemplate cases where a plurality of crawlers run on one single server. As a result, when the above traditional crawlers run on one single server, the acquisition timings at which the individual crawlers acquire may be overlapped with each other. When the overlapping of the acquisition timings of the sensor data becomes excessive, each crawler may not be able to acquire the sensor data at predetermined acquisition timing and the acquisition intervals may be disturbed. As a result, it may happen that the above traditional crawlers cannot maintain the acquisition intervals to acquire the sensor data.

### BRIEF DESCRIPTION OF THE DRAWINGS

FIG. 1 is a diagram illustrating an example of a functional configuration of an information collection system according to a first embodiment;

FIG. 2 is a diagram illustrating an example of a local schedule;

FIG. 3 is a diagram illustrating an example of a hardware configuration of the information collection device of FIG. 1;

FIG. 4 is a diagram explaining a method of adjusting the local schedule;

FIG. 5 is a diagram explaining the method of adjusting the local schedule;

FIG. 6 is a flowchart illustrating an example of processing by an information collection management device of FIG. 1;

FIG. 7 is a flowchart illustrating an example of processing by a peak size adjuster of FIG. 1;

FIG. 8 is a flowchart illustrating an example of processing by a number-of-peaks adjuster of FIG. 1;

FIG. 9 is a flowchart illustrating an example of processing by a peak interval adjuster of FIG. 1;

FIG. 10 is a diagram illustrating an example of a functional configuration of an information collection system according to a second embodiment; and

FIG. 11 is a flowchart illustrating an example of operation of an information collection management device of FIG. 10.

### DETAILED DESCRIPTION

According to one embodiment, an information collection management device includes a computer including at least one processor. The computer is configured to obtain local schedules from a plurality of crawlers, the local schedules each defining a timing of an acquisition process for corresponding one of the crawlers to acquire data; and adjust the local schedules such that overlapping in the acquisition processes is reduced.

Embodiments of the present invention are described below with reference to the drawings.

### First Embodiment

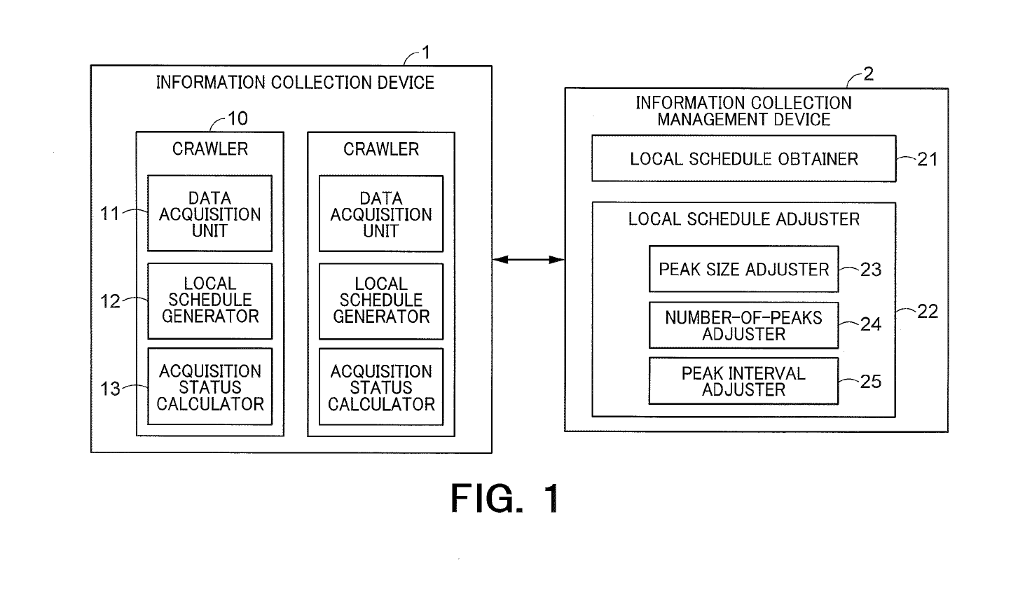

With regard to an information collection device according to a first embodiment, explanations thereof are provided with reference to FIGS. 1 to 9. FIG. 1 is a diagram that illustrates an example of a functional configuration of an information collection system according to this embodiment. As illustrated in FIG. 1, the information collection system includes an information collection device 1 and an information collection management device 2.

First, the information collection device 1 is described.

The information collection device 1 is a device that is connected to a network and adapted to collect various data via the network. The data to be collected by the information collection device 1 can be selected as appropriate depending on intended purposes. In the following descriptions, explanations are provided based on an example where the information collection device 1 collects sensor data from sensor devices installed in a building or a factory.

As illustrated in FIG. 1, the information processing device 1 is configured to execute a plurality of crawlers 10. The crawler 10 is software for the information processing device 1 to acquire data on the network. The crawler 10 runs on a computer 100 that constitutes the information processing device 1. When a virtual machine operates on the computer 100, the crawler 10 may run on the virtual machine. With regard to the computer 100, its details will be described later. In the example of FIG. 1, the information processing device 1 executes two crawlers 10 but three or more crawlers 10 may be executed.

Each of the crawlers 10 includes a data acquisition unit 11, a local schedule generator 12, and an acquisition status calculator 13.

The data acquisition unit 11 is configured to acquire one or more pieces of sensor data, in accordance with a local schedule (which may be hereinafter referred to as “LS”), which will be described later, from one or more sensor devices from which the sensor data is to be acquired. The sensor data acquired by the data acquisition unit 11 is used, for example, in abnormality diagnosis of the sensor devices and calculation of control values to control the sensor devices. In addition, the sensor data may be displayed on a display device connected to the information processing device 1 and may be output on an external device. In the following descriptions, processing for the data acquisition unit 11 to acquire the sensor data from a sensor device X is referred to as the acquisition processing associated with the sensor device X.

The local schedule generator 12 (hereinafter referred to as “LS generator 12”) is configured to generate the LS of the crawler 10. The LS is a schedule that defines a timing for the data acquisition unit 11 of the crawler 10 to acquire the sensor data, i.e., the timing of the acquisition processing. The data acquisition unit 11 is configured to acquire the sensor data from the sensor devices at the timing defined by the LS.

Since the crawler 10 acquires the sensor data periodically, the LS will be given as a schedule that defines the timings of the individual acquisition processes in a predetermined period of time that corresponds to one cycle of the operation of the crawler 10 (hereinafter referred to as “cycle time”).

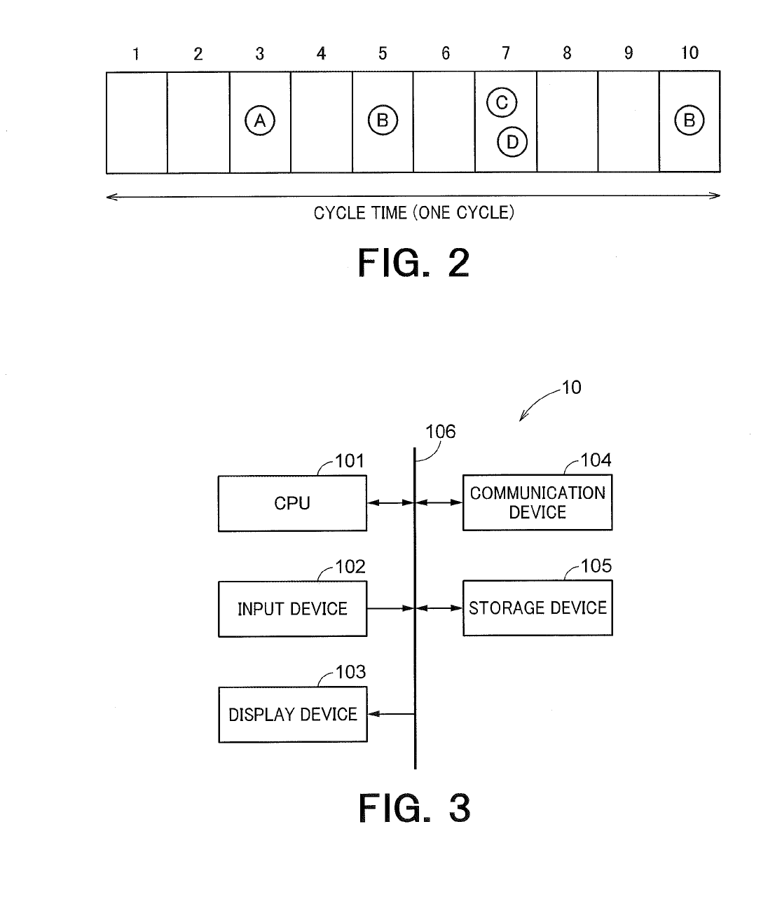

FIG. 2 is a diagram that illustrates an example of the local schedule (LS). In the example of FIG. 2, the cycle time is time-divided into ten time slots 1 to 10. The time slot as used herein refers to a period of time having a predetermined time width and specified by time-division of the cycle time into a predetermined number of periods. For example, if the cycle time is one minute in the LS of FIG. 2, then the time width of each of the time slots will be six seconds. In addition, the first time slot 1 is the period from 0 to 6 seconds, and the second time slot 2 is a period from 6 to 12 seconds. The length of the cycle time is defined depending on the specs of the sensor devices or the like.

As illustrated in FIG. 2, acquisition processes are assigned to the individual time slots in the LS.

In the example of FIG. 2, the acquisition process associated with the sensor device A is assigned to the time slot 3, the acquisition process associated with the sensor device B is assigned to the time slot 5, the acquisition processes associated with the sensor devices C and D are assigned to the time slot 7, and the acquisition process associated with the sensor device B is assigned to the time slot 10.

When the LS of FIG. 2 is abided by, the data acquisition unit 11 acquires the sensor data of the sensor device A in the period of the time slot 3, the sensor data of the sensor device B in the period of the time slot 5, the sensor data of the sensor devices C and D in the period of the time slot 7, and the sensor data of the sensor device B in the period of the time slot 10. In this manner, the LS is a schedule that defines the assignment of the acquisition processes to the individual time slots included in the cycle time.

As described above, it is important that the acquisition intervals are maintained for the sensor data. Meanwhile, the absolute time at which the sensor data is acquired is not important. For this reason, the start time at which acquisition of the sensor data is to be started may be specified as appropriate.

For example, if the acquisition start time is 12:00:00 (hh:mm:ss), the start time for the time slot 1 in the first cycle will be 12:00:00, and the start time for the time slot 1 of the second cycle will be 12:01:00.

Likewise, if the acquisition start time is 12:00:24, the stat time of the time slot 1 in the first cycle will be 12:00:24, and the start time of the time slot 1 in the second cycle will be 12:01:24.

In this manner, when the sensor data is acquired in accordance with the LS, the data acquisition unit 11 is allowed to maintain the acquisition intervals of the sensor data while the acquisition start time is specified as appropriate.

It should be noted that the LS generator 12 may generate the LS described above on the basis of meta information and the like. The meta information may include IDs, types, IP addresses, frequencies of sensor value updates, and communication delay statuses of the sensor devices from which the crawler 10 acquires the sensor data.

The acquisition status calculator 13 is configured to calculate an acquisition status of the sensor data acquired by the data acquisition unit 11.

The acquisition status calculator 13 calculates, as the acquisition status, for example, an error between the acquisition time defined by the LS and an actual acquisition time (hereinafter referred to as “acquisition error”). The acquisition error can be calculated on the basis of the LS, the acquisition start time of the sensor data, and the actual acquisition time. It is preferable that the acquisition error is small. The acquisition status calculator 13 may calculate, in place of or in addition to the acquisition error for each cycle, an average value, a variance, a moving average, or the like of the error.

In addition, the acquisition status calculator 13 may calculate the acquisition intervals of the sensor data for each of the sensor devices as the acquisition status. The acquisition intervals are calculated on the basis of the LS and the actual acquisition time. It is preferable that the acquisition intervals are constant. The acquisition status calculator 13 may calculate, in place of or in addition to the acquisition intervals for each cycle, an average value, a variance, a moving average, or the like of the intervals.

Here, a hardware configuration of the information processing device 1 according to this embodiment is described with reference to FIG. 3. The information processing device 1 according to this embodiment is constituted by a single computer 100. The computer 100 includes a server, a client, a microcontroller, and a general purpose computer.

FIG. 3 is a diagram that illustrates an example of the computer 100. As illustrated in FIG. 3, the computer 100 includes a CPU (central processing unit) 101 being circuitry or a processor, an input device 102, a display device 103, a communication device 104, and a storage device 105, which are interconnected via a bus 106.

The CPU 101 is an electronic circuit that includes a control device and an arithmetic device for the computer 100. The CPU 101 carries out arithmetic processing on the basis of data input from the individual devices (for example, the input device 102, the communication device 104, and the storage device 105) connected via the bus 106 and on the basis of programs, and output the arithmetic results and control signals to the individual devices (for example, the display device 103, the communication device 104, and the storage device 105) connected via the bus 106. Specifically, the CPU 101 is configured to execute an operation system (OS) of the computer 100 and an information collection program and control the individual devices that constitute the computer 100.

The information collection program is a program that causes the computer 100 to realize the above-described individual functional features of the information processing device 1. As described above, the information collection program includes a plurality of the crawlers 10 that are independent of each other. By the operation of the crawlers 10 on the computer 100, the individual functional features of the crawler 10 (the data acquisition unit 11, the LS generator 12, and the acquisition status calculator 13) are realized.

The information collection program is stored in a non-temporary, tangible, computer-readable storage medium. For example, the above-mentioned storage medium may include, but not limited to, an optical disc, a magneto optical disc, a magnetic disc, a magnetic tape, flash memory, and semiconductor memory. By operation of the information collection program by the CPU 101, the computer 100 functions as the information collection device 1.

The input device 102 is a device for inputting information in the computer 100. For example, the input device 102 may include, but not limited to, a keyboard, a mouse, and a touch panel. A user is allowed to input meta information, a sensor-data acquisition start command, and the like by operation of the input device 102.

The display device 103 is a device for displaying images and videos. For example, the display device 103 may include, but not limited to, an LCD (liquid crystal display), a CRT (cathode-ray tube), and PDP (plasma display panel). The sensor data collected by the information collection device 1 can be displayed on the display device 103. It should be noted that the information collection device 1 may have a configuration that does not include the display device 103.

The communication device 104 is a device for wired or wireless communications by the computer 100 with external devices. For example, the communication device 104 may include, but not limited to, a modem, a hub, and a router. The information processing device 1 is connected to the network via the communication device 104.

The storage device 105 is a storage medium that stores the operating system (OS) of the computer 100, the information collection program, data necessary for execution of the information collection program, the data generated by the execution of the information collection program, and the like. The storage device 105 includes a main storage device and an external storage device. For example, the main storage device may include, but not limited to, RAM, DRAM, and SRAM. In addition, for example, the external storage device may include, but not limited to, a hard disk, optical disc, flash memory, and a magnetic tape. The sensor data collected by the information collection device 1 is stored in the storage device 105.

It should be noted that the computer 100 may include one or more CPUs 101, one or more input devices 102, one or more display devices 103, one or more communication devices 104, and one or more storage devices 105. And peripheral devices such as a printer and a scanner maybe connected to the computer 100.

In addition, the information collection program may be stored in advance in the storage device 105 of the computer 100, stored in an external storage medium that is external to the computer 100, or uploaded to the Internet. In either case, the functions of the information collection device 1 are realized by installing the information collection program in the computer 100 and executing the installed information collection program.

Next, the information collection management device 2 is described.

The information collection management device 2 is a device that manages collection of the data by the information collection device 1. In this embodiment, the information collection management device 2 is configured to manage the LSs of the crawlers 10 executed by the information collection device 1. As illustrated in FIG. 1, the information collection management device 2 includes a local schedule obtainer 21 and a local schedule adjuster 22.

The local schedule obtainer 21 (hereinafter referred to as “LS obtainer 21”) is configured to obtain the individual LSs generated by the individual LS generators 12 of the crawlers 10 from the plurality of crawlers 10 executed by the information collection device 1. In the example of FIG. 1, the LS obtainer 21 obtains two LSs. The LS obtainer 21 may obtain all the LSs at one time or may sequentially obtain the LSs one at a time.

The local schedule adjuster 22 (hereinafter referred to as “LS adjuster 22”) is configured to adjust the plurality of LSs obtained by the LS obtainer 21 such that overlapping of the acquisition processes is reduced. The overlapping of the acquisition process as used herein refers to the fact that a plurality of acquisition processes are executed at the same timing.

As the method of reducing the overlapping of the acquisition processes, a method of reducing the number of the acquisition processes and a method of reducing the timings at which the acquisition processes overlap with each other may be contemplated. The method of reducing the overlapping of the acquisition processes will be described later in detail below.

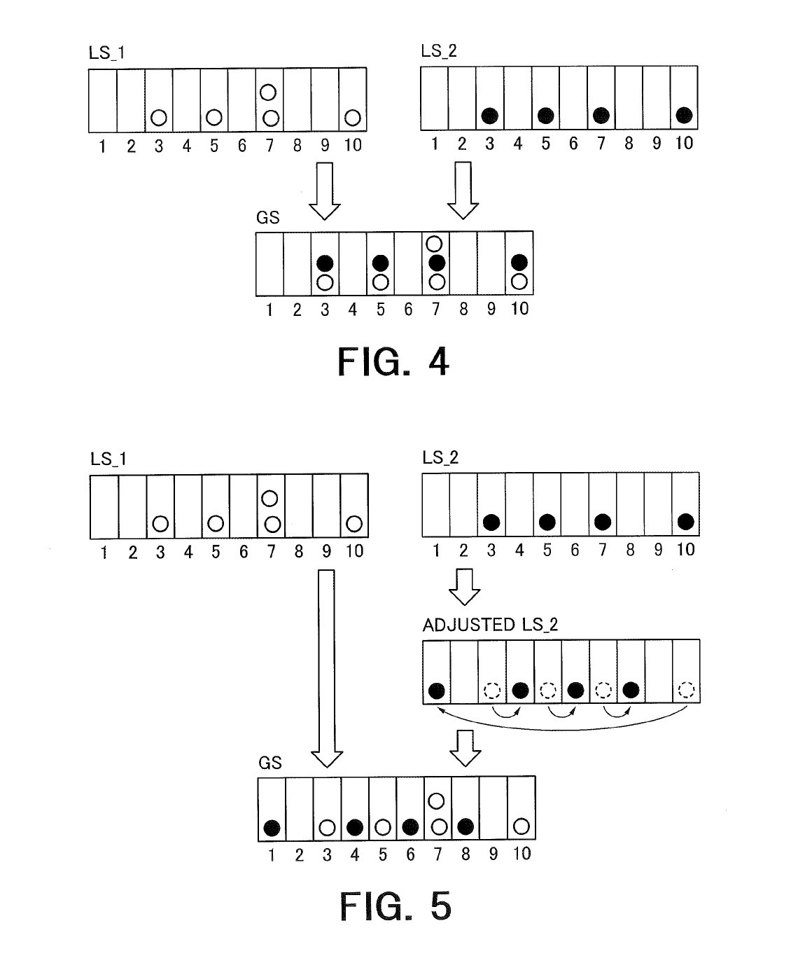

Here, the method of adjusting the LSs is described with reference to FIGS. 4 and 5. FIG. 4 is a diagram that illustrates an example of the LSs obtained by the LS obtainer 21. In the example of FIG. 4, two LSs are obtained. One of these obtained LSs is called local schedule LS_1, and the other is called local schedule LS_2. In addition, the crawler 10 which acquires the sensor data in accordance with the local schedule LS_1 is called the crawler 10_1, and the crawler 10 which acquires the sensor data in accordance with the LS_2 is called the crawler 10_2.

As illustrated in FIG. 4, in the local schedule LS_1, one acquisition process is assigned to each of the time slots 3, 5, and 10 whilst two acquisition processes are assigned to the time slot 7. Likewise, in the local schedule LS_2, one acquisition process is assigned to each of the time slots 3, 5, 7, and 10. It is assumed here that the cycle time of the local schedule LS_1 is identical to that of the local schedule LS_2.

When the acquisition start time of the crawler 10_1 is identical to that of the crawler 10_2, then both of the crawlers 10_1 and 10_2 execute the acquisition processes in the time slots 3, 5, 7, and 10. Specifically, the acquisition processes are overlapped with each other in the time slots 3, 5, 7, and 10. As described above, the crawlers 10_1 and 10_2 operate on the one single computer 100. If the acquisition processes are excessively overlapped with each other, deviation (i.e., missing) of the timings of the acquisition processes may occur, which in turn causes disturbance in the acquisition intervals.

In order to reduce such overlapping of the acquisition processes, the LS adjuster 22 generates first a global schedule (hereinafter referred to as “GS”). The GS is a schedule constituted by overlaying the obtained LSs. In the example of FIG. 4, the GS is generated by overlaying the local schedule LS_1 upon the local schedule LS_2. In the GS of FIG. 4, two acquisition processes are assigned to each of the time slots 3, 5, and 10 whilst three acquisition processes are assigned to the time slot 7.

Next, the LS adjuster 22 adjusts at least one LS from among the LSs such that the overlapping of the acquisition processes in the generated GS is reduced. The “adjustment of at least one LS” as used herein refers to shifting (displacing) each acquisition process assigned to each time slot of the LSs by a predetermined number of time slots. In the following, explanations are provided on the basis of an example where the LS adjuster 22 adjusts the local schedule LS_2 only.

FIG. 5 is a diagram that illustrates the LS_2 that has been adjusted by the LS adjuster 22 (hereinafter referred to as “adjusted local schedule LS_2”). The adjusted local schedule LS_2 is a local schedule whose acquisition processes each assigned to the corresponding time slots of the LS_2 that is yet to be adjusted are shifted rearward by one time slot.

Through adjusting the local schedule LS_2 in this manner, the acquisition processes assigned to the time slots 3, 5, 7, and 10 of the local schedule LS_2 are shifted to reside now in the time slots 4, 6, 8, and 1 of the adjusted local schedule LS_2, respectively. Specifically, in the adjusted local schedule LS_2, as illustrated in FIG. 5, one acquisition process is assigned to each of the time slots 4, 6, 8, and 1. The reason why the acquisition process assigned to the time slot 10 is shifted to reside in the time slot 1 is that the next time shift with respect to the time slot 10 will be the time slot 1 of the next cycle.

As can be appreciated from FIG. 5, the time intervals of each acquisition process are maintained even though the acquisition processes each assigned to the corresponding time slots of the LS are shifted by the predetermined number of time slots.

The GS of FIG. 5 is generated by overlaying the local schedule LS_1 on the adjusted local schedule LS_2. In the GS of FIG. 5, one acquisition process is assigned to each of the time slots 1, 3 to 6, 8, and 10 whilst two acquisition processes are assigned to the time slot 7.

As can be appreciated from FIGS. 4 and 5, the GS after the adjustment of the LS have reduced the overlapping of the acquisition processes assigned to each time slot of the GS before the adjustment of the LS. For example, in the GS of FIG. 4, up to three acquisition processes are overlapped with each other, in contrast to which, in the GS of FIG. 5, not more than two acquisition processes are overlapped with each other.

In this manner, the LS adjuster 22 adjusts the LSs such that the overlapping of the acquisition processes assigned to each time slot of the GS is reduced, and returns the adjusted LSs to the crawlers 10. The crawlers 10 to which the LSs have been returned acquire the sensor data in accordance with the adjusted LSs that has been returned from the LS adjuster 22.

The method of reducing the overlapping of the acquisition processes is described hereinbelow. As illustrated in FIG. 1, the LS adjuster 22 includes a peak size adjuster 23, a number-of-peaks adjuster 24, and a peak interval adjuster 25.

The peak size adjuster 23 is configured to adjust the size of a peak in the GS (hereinafter referred to as “peak size”). The “peak” as used herein refers to the time slot having the maximum number of the acquisition processes assigned in the GS. The “size” as used herein refers to the number of the acquisition processes assigned to each time slot of the GS. Accordingly, the “peak size” will be the maximum value of the number of the acquisition processes assigned to one single time slot in the GS.

For example, in the GS of FIG. 4, the peak is the time slot 7 and the peak size is 3. In addition, in the GS of FIG. 5, the peak is the time slot 7 and the peak size is 2.

Larger peak size leads to higher possibility of the deviation of the acquisition timing at the peak. Through adjusting the LSs by the peak size adjuster 23 such that the peak size becomes small, it is made possible to reduce the possibility of the deviation of the acquisition timing and prevent disturbance in the acquisition intervals. It is preferable that the peak size adjuster 23 adjusts the LSs such that the peak size becomes the smallest.

In addition, the peak size adjuster 23 may adjust the LSs such that the peak size becomes larger. When the LSs are adjusted such that the peak size becomes larger, many acquisition processes are overlapped with each other at the peak, which causes disturbance in the acquisition intervals. However, as the acquisition processes are concentrated at the peak, overlapping of the acquisition processes in time slots other than the peak is mitigated. Accordingly, the possibility that the acquisition intervals can be accurately maintained is increased in the time slots other than the peak. As a result, there may be cases where the average value of the deviations of the acquisition intervals at each cycle can be reduced. It is preferable that the peak size adjuster 23 adjusts the LSs such that the peak size is maximized.

It should be noted that whether the peak size should be reduced or enlarged by the peak size adjuster 23 may be specified in advance by a user of the information collection management device 2 or may be switched in accordance with the number of the crawlers 10 running on the information collection device 1. In addition, the adjustment methods may be selected by comparing the average value of the deviations of the acquisition intervals when the peak size is enlarged with the average value of the deviations of the acquisition intervals when the peak size is reduced to select the adjustment method whose average value of deviations is smaller than the other.

In addition, if a plurality of methods of adjusting the LSs wherein the peak size is minimized or maximized exist, then the peak size adjuster 23 may randomly select one adjustment method from the adjustment methods. In addition, the adjustment method may be selected by another method from among the adjustment method that minimize or maximize the peak size.

The number-of-peaks adjuster 24 is configured to adjust the LS such that the number of peaks (hereinafter referred to as “number of peaks”) in the GS becomes smaller. For example, since the time slot 7 is the only one peak in the GS of FIGS. 4 and 5, the number of peaks is 1.

Many time slots having a high possibility of deviation of the acquisition timings will exist in proportion to the number of peaks, as a result of which the possibility of deviation in the acquisition timing becomes high. Through adjusting the LSs by the number-of-peaks adjuster 24 such that the number of peaks becomes small, it is made possible to reduce the possibility of deviation of the acquisition timing and prevent the disturbance of the acquisition intervals. It is preferable that the number-of-peaks adjuster 24 adjusts the LSs such that the number of peaks is minimized.

It should be noted that, if a plurality of methods of adjusting the LSs wherein the number of peaks is minimized exist, the number-of-peaks adjuster 24 may randomly select one adjustment method from the adjustment methods. In addition, the adjustment method may be selected by another method from the adjustment method that minimizes the number of peaks.

The peak interval adjuster 25 is configured to adjust the LSs such that the interval between the peaks in the GS (hereinafter referred to as “the peak interval”) becomes larger. For example, since the time slot 7 is the only one peak in the GS of FIGS. 4 and 5, the peak interval is one cycle (10 time slots).

In contrast, when there are a plurality of peaks in one GS, there will also be a plurality of peak intervals. In such a case, the peak interval adjuster 25 should adjust the LSs such that the maximum value or an average value of the peak intervals becomes larger.

More acquisition processes will be concentrated in the period including the peak in proportion to a smaller peak interval, as a result of which the possibility of deviation in the acquisition timing becomes high. Through adjusting the LSs by the peak interval adjuster 25 such that the peak intervals become larger, it is made possible to reduce the possibility of deviation in the acquisition timings and prevent the disturbance of the acquisition intervals. It is preferable that the peak interval adjuster 25 adjusts the LS such that the peak intervals are maximized.

It should be noted that, if a plurality of methods of adjusting the LSs wherein the peak interval is maximized exist, then the peak interval adjuster 25 may randomly select one adjustment method from the adjustment methods. In addition, an adjustment method may be selected by another method from the adjustment methods that maximize the peak interval.

It should be noted that the LS adjuster 22 may have a configuration according to which the LS adjuster 22 only includes one or two selected from the peak size adjuster 23, the number-of-peaks adjuster 24, and the peak interval adjuster 25. In addition, the LS adjuster 22 may select any one of the peak size adjuster 23, the number-of-peaks adjuster 24, and the peak interval adjuster 25 in accordance with a request of the user or the like. Further, the LS adjuster 22 may adjust the LSs by using the peak size adjuster 23, the number-of-peaks adjuster 24, and the peak interval adjuster 25 in accordance with a predetermined order of priority.

The hardware configuration of information processing management device 2 according to this embodiment is described hereinbelow. The information processing management device 2 according to this embodiment is constituted by the computer 100 in the same manner as in the information processing device 1. Specifically, the information processing management device 2 is configured by the computer 100 executing the information processing management program realizing the above-described individual features. The explanation of the configuration of the computer 100 is omitted.

The information processing device 1 and the information processing management device 2 may be constituted by one and the same computer 100 or may be constituted by the computers 100 that are different from each other. When the information processing device 1 and the information processing management device 2 are constituted by the different computers 100, the computers 100 are connected to each other via the bus 106 and the communication device 104.

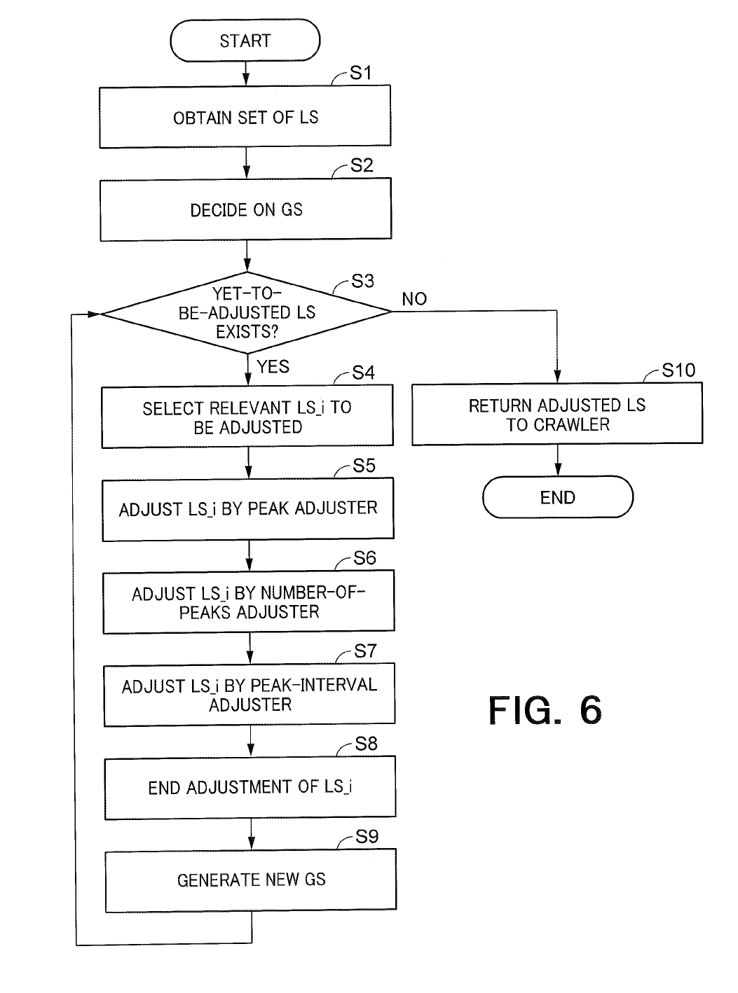

Next, the processing by the information collection management device 2 according to this embodiment is described with reference to FIGS. 6 to 9. In the following descriptions, explanations are provided on the basis of an example where the information collection management device 2 uses the peak size adjuster 23, the number-of-peaks adjuster 24, and the peak interval adjuster 25 according to predetermined order of priority and this adjusts the LSs. It is assumed here that the information collection management device 2 uses the peak size adjuster 23, the number-of-peaks adjuster 24, and the peak interval adjuster 25 in this order and thus adjusts the LSs. FIG. 6 is a flowchart that illustrates the processing like this by the information collection management device 2.

As illustrated in FIG. 6, first, the LS obtainer 21 obtains the respective LSs from the crawlers 10 executed by the information collection device 1. By virtue of this, a plurality of LSs (hereinafter referred to as “a set of LSs”) are obtained (the step S1). The LS obtainer 21 passes the obtained set of LSs to the LS adjuster 22.

When the LS adjuster 22 has received the set of LSs from the LS obtainer 21, the LS adjuster 22 selects one LS from the set of LSs and decides the selected LS as the GS (the step S2). The LS adjuster 22 can decide any LS as the GS.

Next, the LS adjuster 22 determines whether or not there exists any LS that is yet to be adjusted in the set of LSs (the step S3). The “LS that is yet to be adjusted” (or “yet-to-be-adjusted LS”) as used herein refers to an LS that is not determined as the GS in the set of LSs and is not yet subjected to the adjustment processing of the steps S4 to S9 which will be explained below.

When there are LSs that are yet to be adjusted (YES in the step S3), the LS adjuster 22 selects one LS to be adjusted from among the yet-to-be-adjusted LSs (the step S4). The selected LS is called local schedule LS_i. The symbol i is an identification number of the LSs, for example, a serial number that begins with 1.

When the LS adjuster 22 selects the local schedule LS_i, the LS adjuster 22 first adjusts the local schedule LS_i by the peak size adjuster 23 (the step S5). The processing by the peak size adjuster 23 will be described later in detail.

Next, the LS adjuster 22 adjusts the local schedule LS_i by the number-of-peaks adjuster 24 (the step S6). The processing by the number-of-peaks adjuster 24 will be described later in detail.

Subsequently, the LS adjuster 22 adjusts the local schedule LS_i by the peak interval adjuster 25 (the step S7). The processing by the peak interval adjuster 25 will be described later in detail.

By the above-described processing procedures, adjustment of the local schedule LS_i is completed and the adjusted local schedule LS_i is generated (the step S8).

The LS adjuster 22 generates a new GS by overlapping the GS determined or generated at this point with the generated adjusted local schedule LS_i (the step S9). After that, the process goes back to the step S3.

Thereafter, the adjustment processing of the steps S3 to S9 is repeated until no more yet-to-be-adjusted LS remains to exist. When no yet-to-be-adjusted LS exists (NO in the step S3), the LS adjuster 22 returns each of the adjusted LSs to the corresponding one of the crawlers 10 and the adjustment processing is completed. Each crawler 10 acquires the data in accordance with its adjusted LS that has been returned from the LS adjuster 22.

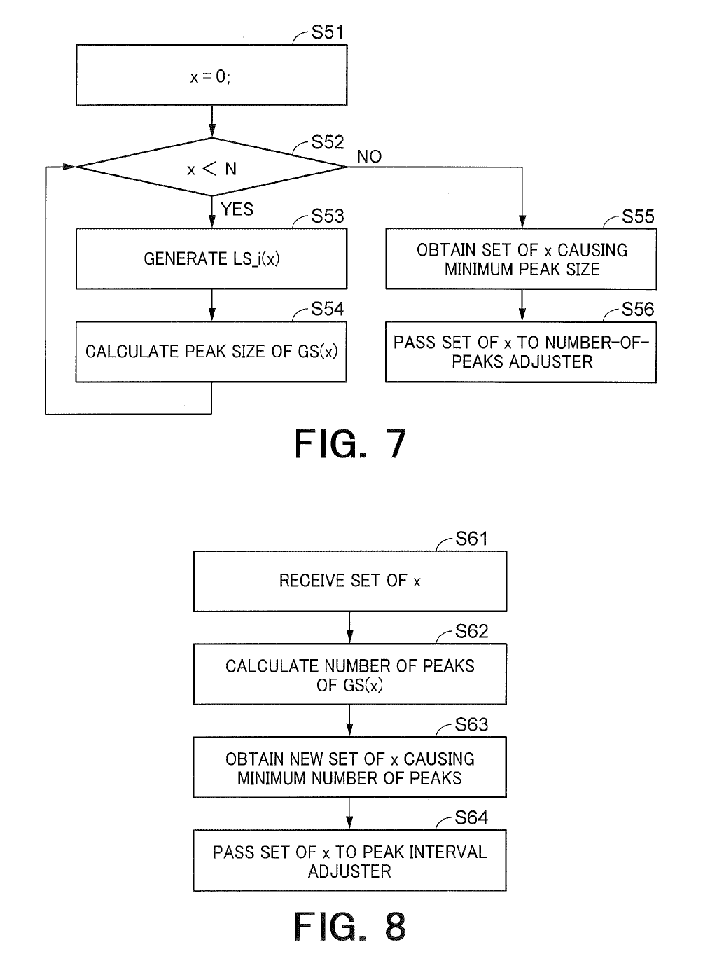

FIG. 7 is a flowchart that illustrates an example of the processing of the peak size adjuster 23. The processing of FIG. 7 corresponds to the procedure of the step S5 in FIG. 6. In the example of FIG. 7, the peak size adjuster 23 adjusts the local schedule LS_i such that the peak size is minimized. In the following descriptions, the number of time slots by which the shifting by the peak size adjuster 23 is made is represented by “x.” In addition, the local schedule LS_i whose acquisition process is shifted by the x time slots is represented by LS_i (x).

First, when the peak size adjuster 23 has received the local schedule LS_i, the peak size adjuster 23 sets the value x to the default value 0 (the step S51). Next, the peak size adjuster 23 determines whether or not the value x is smaller than N (the step S52), where N is the number of time slots included in the local schedule LS_i.

If the value x is smaller than N (YES in the step S52), the peak size adjuster 23 shifts the local schedule LS_i by the amount corresponding to the value x and generates the local schedule LS_i (x) (the step S53). And the peak size adjuster 23 calculates the peak size of the GS (x) which is generated by overlaying the local schedule LS_i (x) upon the GS (the step S54). At this point, the GS is not updated. After that, the process goes back to the step S52.

Thereafter, the processing of the steps S52 to S54 is repeated until the value x agrees with N. Specifically, the peak size adjuster 23 executes the processing of the steps S53 and S54 for the values x=0 to N−1.

When the value x agrees with N (NO in the step S52), the peak size adjuster 23 obtains one or more values x (hereinafter referred to as “a set of values x”) that causes the peak size of global schedule GS (x) to become minimized from among the values x (=0 to N−1) for which the processing has been executed (the step S55). In addition, the peak size adjuster 23 passes the obtained set of values x to the number-of-peaks adjuster 24 (the step S56).

It should be noted that, when the value x that causes the peak size to be minimized has been uniquely identified, the LS adjuster 22 may terminate the adjustment of the local schedule LS_i (the step S8). In this case, the adjusted local schedule LS_i will be the local schedule LS_i (x).

FIG. 8 is a flowchart that illustrates an example of the processing by the number-of-peaks adjuster 24. The processing of FIG. 8 corresponds to the procedure of the step S6 in FIG. 6. In the example of FIG. 8, the number-of-peaks adjuster 24 adjusts the local schedule LS_i such that the number of peaks is minimized.

First, the number-of-peaks adjuster 24 receives the set of values x from the peak size adjuster 23 (the step S61). Next, the number-of-peaks adjuster 24 calculates the number of peaks of the global schedule GS (x) in terms of all the values x included in the set of values x (the step S62). In addition, the number-of-peaks adjuster 24 obtains, from among the set of values x received from the peak size adjuster 23, a new set of values x that causes the number of peaks of the GS (x) to become minimized (the step S63). In addition, the number-of-peaks adjuster 24 passes the new set of values x to the peak interval adjuster 25 (the step S64).

It should be noted that, when the value x that causes the number of peaks to become minimized has been uniquely identified, the LS adjuster 22 may terminate the adjustment of the local schedule LS_i (the step S8). In this case, the adjusted local schedule LS_i will be the local schedule LS_i (x).

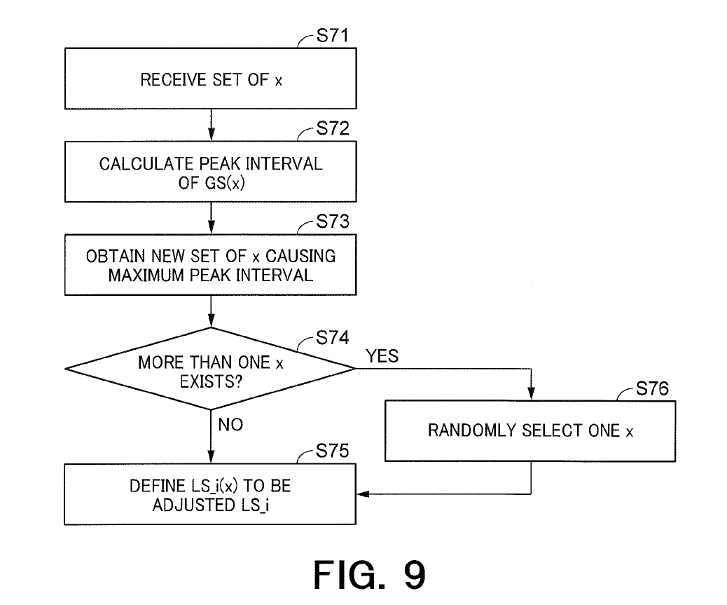

FIG. 9 is a flowchart that illustrates an example of the processing by the peak interval adjuster 25. The processing of FIG. 9 corresponds to the procedure of the step S7 in FIG. 6. In the example of FIG. 9, the peak interval adjuster 25 adjusts the local schedule LS_i such that the peak interval is maximized.

First, the peak interval adjuster 25 receives the set of values x from the number-of-peaks adjuster 24 (the step S71). Next, the peak interval adjuster 25 calculates the peak interval of the GS (x) in terms of all the values x included in the set of values x (the step S72). In addition, the peak interval adjuster 25 obtains a new set of values x that causes the peak interval of the GS (x) becomes maximized from among the set of values x that have been received from the number-of-peaks adjuster 24 (the step S73).

The peak interval adjuster 25 determines whether or not a plurality of values x are included in the obtained set of values x (the step S74). If only one value x is included in the set of values x (NO in the step S74), the peak interval adjuster 25 decides, as the adjusted LS_i, the local schedule LS_i (x) whose local schedule LS_i has been shifted by the amount equal to the values x included in the set of values x (the step S75).

Meanwhile, if more than one value x is included in the set of values x (YES in the step S74), the peak interval adjuster 25 randomly selects one value x from among the values x included in the set of values x (the step S76).

In addition, the peak interval adjuster 25 decides, as the adjusted local schedule LS_i, the local schedule LS_i (x) whose local schedule LS_i has been shifted by the amount equal to the selected value x (the step S75).

It is preferable that the information collection management device 2 carries out the above-described processing before each crawler 10 starts to acquire the data. This is because the acquisition intervals of the data by the crawler 10 are disturbed when the LS is changed after the start of the data acquisition.

In addition, if a new crawler 10 has been added to the information collection device 1 after the LSs were adjusted by the above-described processing and each crawler 10 started the data acquisition in accordance with the adjusted LS, then the information collection management device 2 may only adjust an LS of the new crawler 10 or may adjust the LSs of all the crawlers 10.

When only the LS of the new crawler 10 is to be adjusted, then the information collection management device 2 should store the GS generated at the time of the adjustment of the LSs of the crawler 10 that are currently running and execute the processing of the steps S4 to S10 for the stored GS and the LS of the new crawler 10.

In accordance with this adjustment method, since only one LS needs to be adjusted, the adjustment processing can be accelerated. In addition, since the LSs of the currently running crawlers 10 are not affected, the acquisition intervals to acquire the data by the currently running crawler 10 is not disturbed.

Meanwhile, when the LSs of all of the crawlers 10 are to be adjusted, the information collection management device 2 should obtain the LSs of the currently running crawlers 10 and the new crawler 10 as the set of LSs (the step S1) and execute the processing of the step S1 to S10.

In accordance with this adjustment method, it is possible that the LSs can be adjusted such that the overlapping of the acquisition process is further reduced compared with cases where only new LS is adjusted.

Further, in the adjustment processing of FIG. 6, it is possible that different adjusted LSs are obtained depending on the order of selection of the local schedule LS_i. For this reason, the LS adjuster 22 may carry out the processing of FIG. 6 for multiple times while randomly selecting the local schedule LS_i. By virtue of this, a plurality of sets of the adjusted LSs can be obtained. The LS adjuster 22 may adopt the set of the adjusted LSs associated with the smallest peak size or the smallest number of peaks of the corresponding GS in the sets of the adjusted LSs as the adjusted LS to be returned to the crawler 10.

As has been described in the foregoing, the information collection management device 2 according to this embodiment can adjust the LSs such that the overlapping of the acquisition processes of the crawlers 10 can be reduced. By virtue of this, even in cases where multiple crawlers 10 run on one single computer 100, the acquisition timings of the sensor data by the individual crawlers 10 becomes more resistant to the deviation, so that it is made possible to prevent disturbance in the acquisition intervals of the sensor data.

It should be noted that the foregoing explanations presuppose a case where the cycle times of the individual crawlers 10 are identical to each other. Meanwhile, the cycle times of the individual crawlers 10 may be different from each other. If the cycle times are different from each other, the cycle time of the GS should be given as the least common multiple of the cycle times of the individual crawlers. For example, if the cycle time of LS_1 in FIG. 4 is one minute and the cycle time of LS_2 is two minutes, then the cycle time of the GS should be given as two minutes. Specifically, the GS should be generated by overlapping the LS_2 with two cycles of the local schedule LS_1.

In addition, in the foregoing explanations, the peak size adjuster 23 adjusts the LSs such that the peak size becomes minimized. Meanwhile, the peak size adjuster 23 may carry out the adjustment such that the peak size becomes maximized. In this case, in the step S55 of FIG. 7, the peak size adjuster 23 should obtain the set of values x that cause the peak size of the global schedule GS (x) to become maximized from the values x (=0 to N−1) with which the processing has been executed. The other processing procedures (the steps S51 to S54, and S56) are the same as or similar to those in the case where the peak size is minimized.

### Second Embodiment

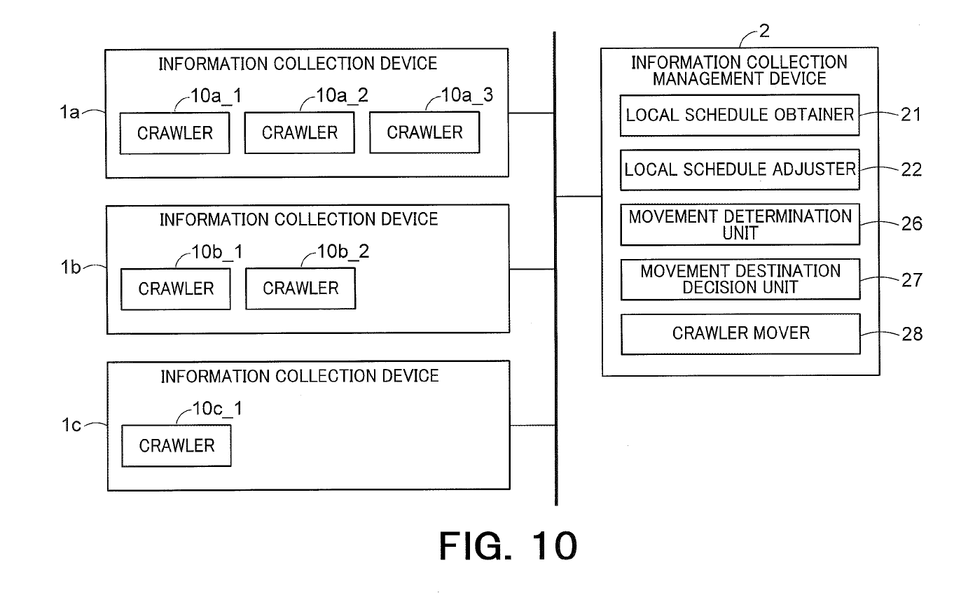

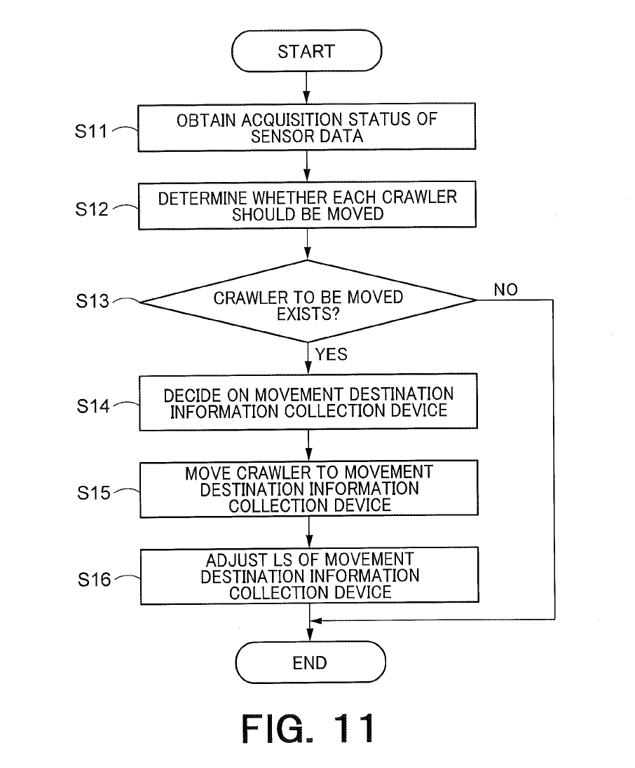

An information collection system according to a second embodiment is described with reference to FIGS. 10 and 11. In the first embodiment, the information collection management device 2 has been explained that reduces the overlapping of the acquisition processes by adjusting the LSs. However, in proportion to increase in the number of the crawlers 10 executed by the information collection device 1, it becomes difficult to reduce the overlapping of the acquisition processes by adjusting the LSs. As a result, it may happen that the acquisition intervals are disturbed. In view of this, in this embodiment, an information collection management device 2 is described that moves the crawler 10 whose acquisition status is deteriorated to another information collection device 1′ when the number of the crawlers 10 executed by the information collection device 1 increases and the acquisition status of the sensor data is deteriorated.

FIG. 10 is a diagram that illustrates an example of the functional configuration of the information collection system according to this embodiment. As illustrated in FIG. 10, the information collection system according to this embodiment includes a plurality of information collection devices 1 and an information collection management device 2.

The plurality of information collection devices 1 are connected to each other via the bus 106 and the communication device 104. Each information collection device 1 has the same or similar configuration as that in the first embodiment. Specifically, the individual information collection devices 1 are each constituted by one single computer 100 and execute a plurality of crawlers 10.

In the example of FIG. 10, the information collection system includes three information collection devices 1a to 1c. The information collection device 1a is executing three crawlers 10a_1 to 10a_3. The information collection device 1b is executing two crawlers 10b 1, 10b_2. The information collection device 1c is executing one crawler 10c_1. In this manner, the information collection system according to this embodiment may include the information collection device 1 that executes only one crawler 10. In addition, the information collection system may include the information collection device 1 that does not yet execute the crawler 10.

The information collection management device 2 according to this embodiment includes a movement determination unit 26, a movement destination decision unit 27, and a crawler mover 28. The remaining portion of the configuration is the same as that of the first embodiment. In this embodiment, the information collection management device 2 adjusts the LSs for each information collection device 1 and generates the GS.

In the example of FIG. 10, the information collection management device 2 is constituted by the computer 100 that is different from the information collection devices 1a to 1c, and is connected to the information collection devices 1a to 1c via the bus 106 and the communication device 104. However, the information collection management device 2 may be constituted by one and the same computer 100 as that of any one of the information collection devices 1a to 1c in the same or similar manner as in the first embodiment.

The movement determination unit 26 determines whether or not the relevant crawler should be moved on the basis of the acquisition status of the sensor data of the relevant crawler. The “relevant crawler” as used herein refers to the crawler 10 with regard to which the movement determination unit 26 determines the necessity of the movement.

The movement determination unit 26 determines that the relevant crawler should be moved when the acquisition status of the sensor data of the relevant crawler is deteriorated. Specifically, the movement determination unit 26 determines that the relevant crawler should be moved when a probability of success of the acquisition intervals of the sensor data of the relevant crawler is equal to or less than a threshold s₁, or when the maximum value of the dispersion of the acquisition intervals (standard deviation and variance) exceeds the threshold s₂. The “success of the acquisition intervals” as used herein refers to the fact, for example, that the acquisition intervals reside within a predetermined range.

The movement destination decision unit 27 decides on a destination information collection device from one or more other information collection devices 1 included in the information collection system. The “other information collection devices 1” as used herein refers to information collection devices 1 other than the information collection device 1 that is currently executing the relevant crawler among the plurality of information collection devices 1 included in the information collection system. In addition, the “destination information collection device” as used herein refers to the other information collection device 1 to which the relevant crawler is to be moved.

For example, when the crawler 10a_1 is the relevant crawler, the other information collection devices 1 are the information collection device 1b and 1c. Accordingly, the movement destination decision unit 27 decides on the information collection device 1b or the information collection device 1c as the destination information collection device.

The movement destination decision unit 27 decides on, for example, another information collection device 1 having the smallest number of the currently running crawlers 10 as the destination information collection device. When the crawler 10a 1 is the relevant crawler, then the information collection device 1c is decided on as the destination information collection device.

In addition, the movement destination decision unit 27 may decide on another information collection device 1 having a good acquisition status of the sensor data as the destination information collection device. The “information collection device 1 having a good acquisition status” as used herein refers to, for example, an information collection device 1 having a high average value of the probability of success of the acquisition intervals of the crawler 10 that the device executes and an information collection device 1 having a small maximum value or small average value of the dispersion of the acquisition intervals of the crawler 10. The probability of success and the dispersion of the acquisition intervals can be calculated on the basis of the acquisition status of the sensor data of the individual crawlers 10 of the other information collection device 1.

The crawler mover 28 moves the relevant crawler to the destination information collection device. The crawler mover 28 copies, for example, the memory state and the configuration file of the relevant crawler to the destination information collection device, suspends the relevant crawler that runs on the original information collection device 1, and thus moves the relevant crawler. In addition, when the relevant crawler 10 runs on a virtual machine, the crawler mover 28 may carry out live migration of the virtual machine to the destination information collection device and thereby move the relevant crawler for each virtual machine.

Next, the processing by the information collection management device 2 according to this embodiment is described with reference to FIG. 11. In the following descriptions, the explanations are provided on the basis of an example where the crawler 10 executed by the information collection device 1a is to be moved to another information collection device 1b, 1c. FIG. 11 is a flowchart that illustrates an example of such processing by the information collection management device 2.

First, the movement determination unit 26 obtains the acquisition statuses of the sensor data of the crawlers 10a_1, 10a_2, and 10a_3 from the information collection device 1a (the step S11).

Next, the movement determination unit 26 determines whether or not the crawlers 10a_1, 10a_2, and 10a_3 should be moved (the step S12). Specifically, the movement determination unit 26 selects the crawler 10a_1 as the relevant crawler and determines whether or not the crawler 10a_1 should be moved on the basis of the acquisition status of the crawler 10a_1. In the same or similar manner, it is determined whether or not the crawlers 10a_2 and 10a_3 should be moved. The order of determinations regarding the crawlers 10 may be defined as appropriate.

If there is no crawler 10 that has been determined to be moved (NO in the step S13), specifically, if all of the crawlers 10a_1, 10a_2, and 10a_3 have been determined not to be moved, then the process is terminated.

Meanwhile, if there is any crawler 10 that has been determined to be moved (YES in the step S13), the movement determination unit 26 passes the result of the determination to the movement destination decision unit 27. It is assumed here that the crawler 10a_1 has been determined to be moved.

When the movement destination decision unit 27 has received the result of the determination to the effect that the crawler 10a_1 is to be moved, the movement destination decision unit 27 decides on the destination information collection device to which the crawler 10a_1 is to be moved (the step S14). The method of deciding the destination information collection device is as has been described in the foregoing. It is assumed here that the information collection device 1c has been decided as the destination information collection device. The movement destination decision unit 27 passes the information regarding the destination information collection device that has been determined and regarding the crawler 10a_1 to be moved to the crawler mover 28.

Then the crawler mover 28 moves the crawler 10a_1 to the information collection device 1c (the step S15). As a result, the information collection devices 1a, 1b, and 1c will each execute two crawlers 10.

After that, the information collection management device 2 adjusts the LSs of the information collection device 1c for which the crawler 10a_1 has been moved (the step S16). The information collection management device 2 may only adjust the LS of the moved crawler 10a_1 or may adjust the LSs of all of the crawlers 10 that are executed by the information collection device 1c (specifically, the crawler 10c 1 and the crawler 10a_1). The adjustment method of the LSs is the same as or similar to that of the first embodiment.

The information collection management device 2 executes the foregoing processing for each information collection device 1 at a predetermined time interval (for example, one-minute interval and ten-minute interval).

As has been described in the foregoing, when the acquisition statuses of the sensor data by the crawlers 10 have been deteriorated due to increase of the crawlers 10 executed by the information collection device 1, the information collection management device 2 according to this embodiment can move the crawler 10 whose acquisition status has been deteriorated to the other information collection device 1′ having a good acquisition status. By virtue of this, it is made possible to prevent disturbance in the acquisition intervals of the sensor data in the information collection device 1 included in the information collection system.

It should be noted that, when the crawler 10 executed by the information collection device 1 is moved to another information collection device 1′, the acquisition status of the sensor data of each of the crawlers 10 executed by the information collection devices 1, 1 is expected to change.

In view of this, it is preferable that when the crawler 10 is moved, the movement determination unit 26 suspends the determination with regard to the information collection device 1 which is the source of the movement of the crawler 10 and the information collection device 1′ which is the destination of the movement for a predetermined period of time (for example, one minute and ten minutes) after the movement of the crawler 10. Specifically, it is preferable that the movement determination unit 26 does not make the determination of whether or not each of the crawlers 10 that run on the information collection devices 1, 1′ should be moved.

In the above example, it is preferable that, after having moved the crawler 10a 1, the movement determination unit 26 does not make the determination with regard to each of the crawlers 10 executed by the information collection devices 1a, 1c for a predetermined period of time. By virtue of this, it is made possible to more accurately analyze the impacts of movement of the crawler 10.

In addition, it is preferable that the movement destination decision unit 27, after having moved the crawler 10, excludes the information collection device 1 which is the source of the movement of the crawler 10 and the information collection device 1′ which is the destination of the movement, for a predetermined period of time (for example, one minute and ten minutes), from the candidate information processing devices to which the crawler 10 is to be moved.

In the above example, it is preferable that after having moved the crawler 10a 1, the movement destination decision unit 27 excludes the information collection devices 1a, 1c from the candidate destination information collection devices for a predetermined period of time. By virtue of this, it is made possible to more accurately analyze the impacts of the movement of the crawler 10.

Further, another configuration may be contemplated according to which the information collection management device 2 according to this embodiment does not include the LS obtainer 21 and the LS adjuster 22. In this case, the information collection management device 2 is not capable of executing the processing procedure of the step S16 of FIG. 11 but still capable of moving the crawler 10. For this reason, the information collection management device 2 can prevent the disturbance in the acquisition intervals of the sensor data through movement of the crawler 10.

In addition, it is possible to configure the information collection management device 2 according to the first embodiment and the information collection management device 2 according to this embodiment that does not include the LS obtainer 21 and the LS adjuster 22 by the computers 100 different from each other and to use these two devices in combination.

It should be noted that the present invention is not limited to the above-described embodiments as such but the present invention in practice may be effectuated with modifications made to its constituent components without departing from the scope and spirit of the present invention. In addition, various inventions may be formed by combining as appropriate the constituent components disclosed in the above-described embodiments. In addition, for example, configurations may be contemplated wherein some or several constituent components are eliminated from all the constituent components presented in the individual embodiments. Further, constituent components described in different embodiments may be combined as appropriate.

1. An information collection management device, comprising:
a computer including at least one processor,
the computer being configured to:
obtain local schedules from a plurality of crawlers, the local schedules each defining a timing of an acquisition process for corresponding one of the crawlers to acquire data; and
adjust the local schedules such that overlapping in the acquisition processes is reduced.

2. The information collection management device according to claim 1, wherein the local schedule defines assignment of the acquisition processes to a plurality of time slots in a predetermined period of time, the predetermined time being time-divided into the time slots.

3. The information collection management device according to claim 2, wherein the computer is configured to adjust the local schedules by shifting the acquisition process assigned to the time slot of the local schedule by a predetermined number of the time slots.

4. The information collection management device according to claim 3, wherein the computer is configured to adjust the local schedules such that overlapping of the acquisition processes is reduced in a global schedule, the global schedule being obtained by overlaying the local schedules with each other.

5. The information collection management device according to claim 4, wherein the computer is configured to adjust the local schedules on the basis of the number of the acquisition processes assigned to the individual time slots in the global schedule.

6. The information collection management device according to claim 4, wherein the computer includes a peak size adjuster configured to adjust the local schedules such that a peak size is reduced, the peak size being a maximum value of the number of the acquisition processes assigned to the time slots in the global schedule.

7. The information collection management device according to claim 4, wherein the local schedule adjuster includes a number-of-peaks adjuster configured to adjust the local schedule such that the number of peaks becomes small, the number of peaks being the number of the time slots having a maximum number of the assigned acquisition processes in the global schedule.

8. The information collection management device according to claim 4, wherein the local schedule adjuster includes the peak interval adjuster configured to adjust the local schedule such that the peak interval becomes large, the peak interval being an interval between the time slots having a maximum number of the assigned acquisition processes in the global schedule.

9. The information collection management device according to claim 1, wherein the plurality of crawlers operate on a single computer.

10. The information collection management device according to claim 1, wherein
the computer is configured to:
make a determination of whether or not a relevant crawler should be moved, the determination being made on the basis of an acquisition status of the data of the relevant crawler obtained from an information collection device executing the plurality of crawlers;
decide on a destination information collection device to which the relevant crawler is to be moved from one or more other information collection devices; and
move the relevant crawler to the destination information collection device.

11. The information collection management device according to claim 10, wherein the destination information collection device is either the other information collection device having the smallest number of crawlers being executed or the other information collection device having a most favorable acquisition status of the data.

12. The information collection management device according to claim 10, wherein the computer is configured to suspend the determination with regard to the information collection device that was executing the relevant crawler and the destination information collection device for a predetermined period of time after movement of the relevant crawler.

13. The information collection management device according to claim 10, wherein the computer is configured to exclude the destination information collection device from candidates of the destination information collection device to which the other crawlers are to be moved for a predetermined period of time after movement of the relevant crawler.

14. An information collection system, comprising:
an information collection device configured to execute the plurality of crawlers: and
the information collection management device of claim 1,
wherein the crawlers acquires the data according to the local schedules adjusted by the information collection management device.

15. An information collection management method comprising:
obtaining local schedules from a plurality of crawlers, the local schedules each defining a timing of an acquisition process for corresponding one of the crawlers to acquire data; and
adjusting the local schedules such that overlapping in the acquisition processes is reduced.
